(19) United States
(12) Patent Application Publication
(10) Pub. No.: US 2013/0307362 A1
(43) Pub. Date: Nov. 21, 2013

(54) CONDUCTOR SPACER CLIP

(71) Applicant: Bradley D. Chamberlin, Pendleton, IN (US)

(72) Inventor: Bradley D. Chamberlin, Pendleton, IN (US)

(21) Appl. No.: 13/471,705

(22) Filed: May 15, 2012

(51) Int. Cl. H02K 3/38

(52) U.S. Cl. 310/91

(57) ABSTRACT

An assembly of an electric machine includes a plurality of conductor segments each having a turn portion, and a plurality of clips each having a channel member and a bend member, the channel members being attached to respective ones of the conductor segments and thereby holding the respective bend members against the respective turn portions. The attached clips electrically insulate and space adjacent ones of the conductor segments. The bend members prevent adjacent ones of the conductor segments from contacting one another.

### BACKGROUND

The present invention is directed to improved thermal performance of an electric machine and, more particularly, to structure and methods of manufacturing for spacing individual conductors apart from one another.

An electric machine is generally structured for operation as a motor and/or a generator, and may have electrical windings, for example in a rotor and/or in a stator. Such windings may be formed with conductor wire as solid conductor rods or bars that are shaped to be securely held within a core, bobbin, or other structure. The conductors may be formed of copper, aluminum, or other conductive material by various manufacturing operations, including a casting, forging, welding, bending, heat treating, coating, jacketing, or other appropriate processes.

It is often necessary to maintain physical spacing between conductors of different phases or voltage potentials. For example, such spacing may be achieved by administering tight tolerancing controls during the conductor forming process, by use of insulation jacketing, or by the utilization of a spacer inserted between adjacent conductors. Traditionally, such spacers may be formed by using a dielectric paper such as Nomex-Kapton-Nomex (“NKN”), by epoxy coatings, or by use of sleeving materials. However, conventional spacers may tear, become misaligned, be inadvertently removed, be difficult to install, and/or have additional inadequacies, thereby decreasing quality and increasing costs of manufacturing.

In order to operate an electric machine at a high efficiency, the machine is designed to reduce losses of energy. Such energy losses take various forms including friction losses, core losses and hysteresis losses, and result in the generation of waste heat. In some applications, heat must be actively removed from the electric machine to prevent this waste heat from reaching impermissible levels in the windings of the electric machine.

Various apparatus and methods are known for removing heat. One example includes providing the electric machine with a water jacket having fluid passages through which a cooling liquid, such as water, may be circulated to remove heat from the electric machine. Other exemplary methods may include providing an air flow, which may be assisted with a fan, through or across the electric machine to promote cooling. Although various structures and methods have been employed for cooling an electric machine, improvements in cooling electric machines remain desirable.

Traditional conductor spacing materials may reduce or limit the amount of coolant that is able to flow around the conductors. As a result, traditional conductor spacer materials reduce the maximum amount of power that can be achieved from an electric machine.

### SUMMARY

It is desirable to obviate the above-mentioned disadvantages by providing a conductor spacing clip that can be secured to a formed conductor of an electric machine, and a method of manufacturing the same. In certain applications it may be advantageous for a conductor spacing clip to have a small profile, yet still force adequate spacing between adjacent conductors. As a result of such a small profile, the spacer clip occupies less volume and thus interferes less with cooling, thereby improving the thermal performance of an electric machine. By increasing the exposed surface area of the conductors, more heat transfer may occur.

In some applications, when the assembly of a series of windings includes inserting conductor rods and the like into respective individual slots of a structure such as a stator body, there is a possibility that a conductor rod being inserted in a generally axial direction will push against adjacent conductor portions and cause misalignment, abrasion, and various undesirable consequences of contact between conductor rods. The disclosed embodiments include an assembly process where a conductor spacer clip is clipped onto each of a plurality of conductor rods which are then sequentially inserted in a generally axial direction into slots of a conductor holding structure. The conductor spacer clip may have a structure for engaging the respective conductor so that the clip does not become dislodged or misaligned when the conductor rod is inserted into the holding structure. As a result, the assembly process enables improvements in quality, productivity, and cost savings, while the assembled series of windings maintains spacing between conductors.

According to an embodiment, an assembly of an electric machine includes a plurality of conductor segments each having a turn portion, and a plurality of clips each having a channel member and a bend member, the channel members being attached to respective ones of the conductor segments and thereby holding the respective bend members against the respective turn portions. The attached clips electrically insulate and space adjacent ones of the conductor segments, and the bend members prevent adjacent ones of the conductor segments from contacting one another.

According to another embodiment, a method of constructing a coil of an electric machine includes providing a plurality of conductor segments having respective turn portions, providing a plurality of clips each having a channel member and a bend member extending from the channel member, attaching the clips to respective turn portions of the conductor segments, installing the clipped conductor segments into a coil containment structure, and using the bend members of the clips to prevent adjacent ones of the turn portions from contacting.

According to a further embodiment, a clip for electrically insulating and spacing adjacent conductors of an electric machine includes at least one channel member formed to at least partially enclose a cross-sectional area of an individual one of the conductors, and at least one bend member extending from the channel member, the channel member being structured to hold the bend member in place against a conductor turn portion when the clip is attached to the conductor.

According to an additional embodiment, an assembly of an electric machine includes a plurality of conductor segments each having a turn portion, and a plurality of clips each having a pair of channel members attached to respective ones of the conductor segments proximate the respective turn portions, where the attached clips space adjacent ones of the conductor segments, and where the channel member pairs prevent adjacent ones of the conductor segments from contacting one another.

The foregoing summary does not limit the invention, which is defined by the attached claims. Similarly, neither the title nor the abstract is to be taken as limiting in any way the scope of the disclosed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic view of an electric machine;

FIG. 2A is a top plan view of a stator body of an electric machine, and FIG. 2B is an enlarged segment thereof;

FIG. 3A is a cross sectional view of a conductor bar, FIG. 3B is a conductor bar segment, and FIG. 3C is a perspective view of a portion of an axial end of a stator, showing bent end portions of adjacent conductor bars;

FIG. 4 is a perspective view of a conductor spacer clip, according to an exemplary embodiment;

FIG. 5 is a perspective view of the conductor spacer clip of FIG. 4 attached to a conductor bar, according to an exemplary embodiment;

FIG. 6 is another perspective view of the conductor spacer clip of FIG. 4 attached to a conductor bar, according to an exemplary embodiment;

FIG. 7 is a further perspective view of the conductor spacer clip of FIG. 4 attached to a conductor bar, according to an exemplary embodiment;

FIG. 8 is a perspective view of a portion of an axial end of a stator, showing bent end portions of adjacent conductors each having a conductor spacer clip of FIG. 4 installed thereon, according to an exemplary embodiment;

FIG. 9 is a perspective view of a conductor spacer clip, according to an exemplary embodiment;

FIG. 10 is another perspective view of the conductor spacer clip of FIG. 9;

FIG. 11 is a perspective view of the conductor spacer clip of FIG. 9 attached to the apex portion of a conductor bar, according to an exemplary embodiment;

FIG. 12 is another perspective view of the conductor spacer clip of FIG. 9 attached to the apex portion of a conductor bar, according to an exemplary embodiment;

FIG. 13A and FIG. 13B are perspective views of a conductor spacer clip, according to an exemplary embodiment;

FIG. 14 is a perspective view of the conductor spacer clip of FIGS. 13A, 13B attached to the apex portion of a conductor bar, according to an exemplary embodiment;

FIG. 15 is a perspective view of a conductor spacer clip, according to an exemplary embodiment;

FIG. 16 is a perspective view of the conductor spacer clip of FIG. 15 being attached to the apex portion of a conductor bar segment, according to an exemplary embodiment;

FIG. 17 is a partial perspective view of an assembled stator, showing two different conductor spacer clips attached to respective inner and outer conductor segments, according to an exemplary embodiment; and

FIG. 18 is a flowchart of a method of manufacturing a stator, according to an exemplary embodiment.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of these teachings.

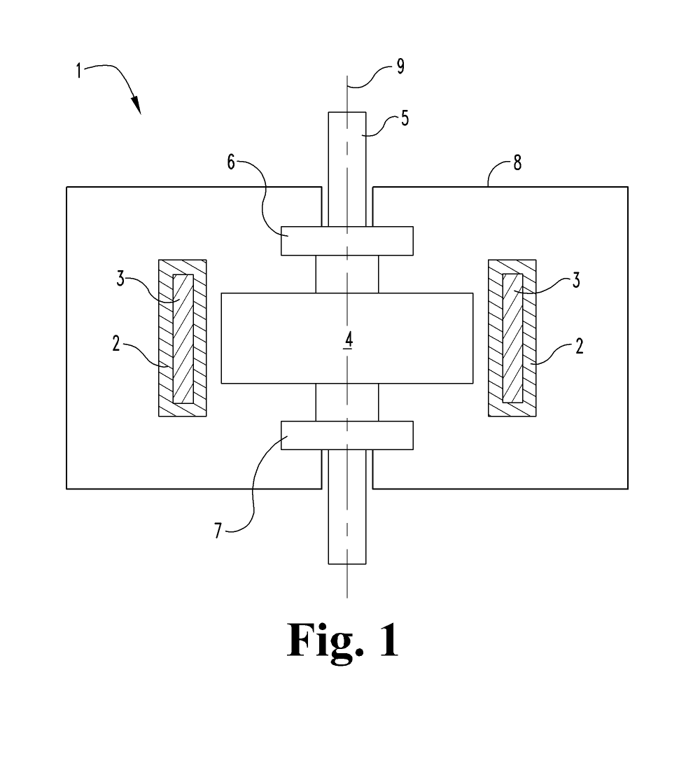

FIG. 1 is a schematic view of an exemplary electric machine 1 having a stator 2 that includes stator windings 3 such as one or more coils. An annular rotor body 4 may also contain windings and/or permanent magnets and/or conductor bars such as those formed by a die-casting process. Rotor body 4 is part of a rotor that includes an output shaft 5 supported by a front bearing assembly 6 and a rear bearing assembly 7. Bearing assemblies 6, 7 are secured to a housing 8. Typically, stator 2 and rotor body 4 are essentially cylindrical in shape and are concentric with a central longitudinal axis 9. Although rotor body 4 is shown radially inward of stator 2, rotor body 4 in various embodiments may alternatively be formed radially outward of stator 2. Electric machine 1 may be an induction motor/generator or other device. In an exemplary embodiment, electric machine 1 may be a traction motor for a hybrid or electric type vehicle. Housing 8 may have a plurality of longitudinally extending fins (not shown) formed to be spaced from one another on a housing external surface for dissipating heat produced in the stator windings 3.

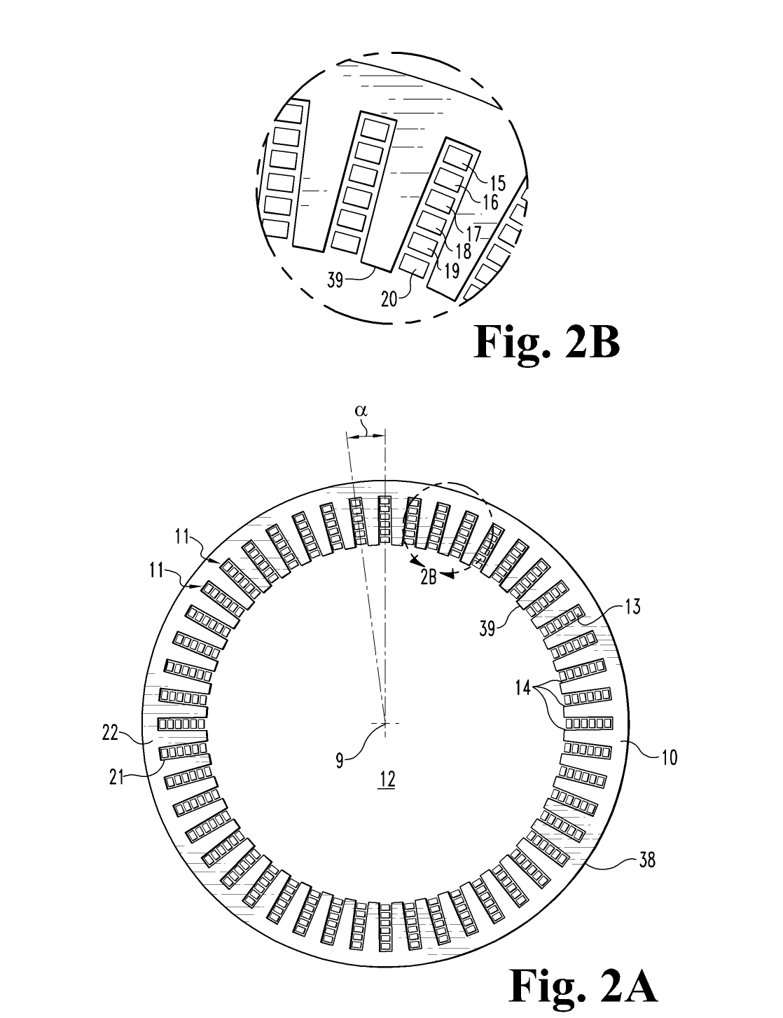

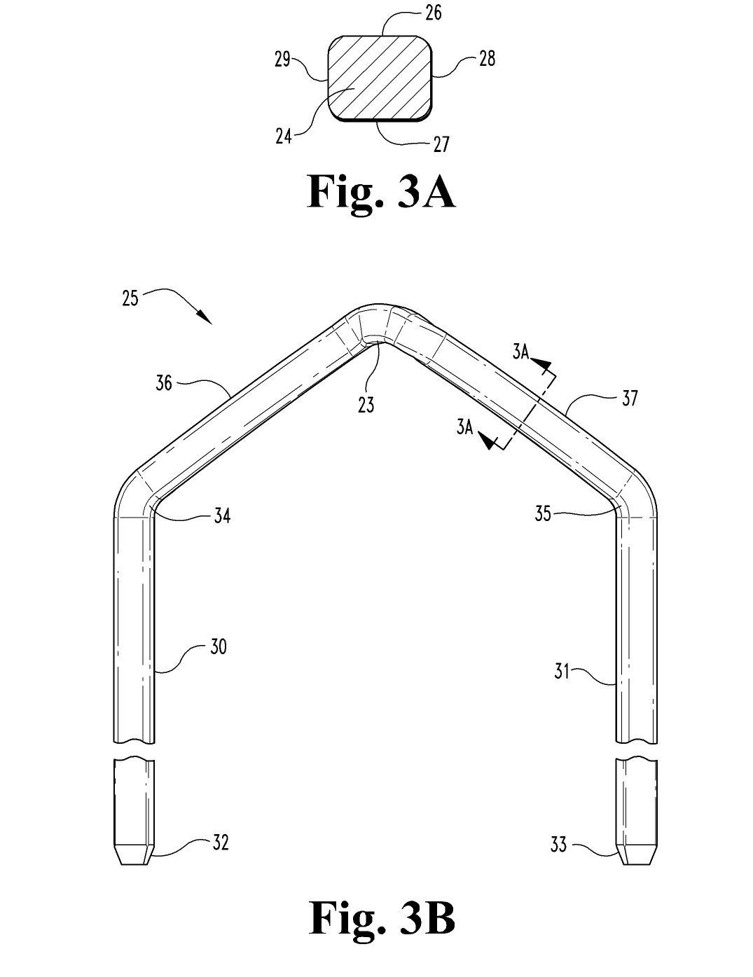

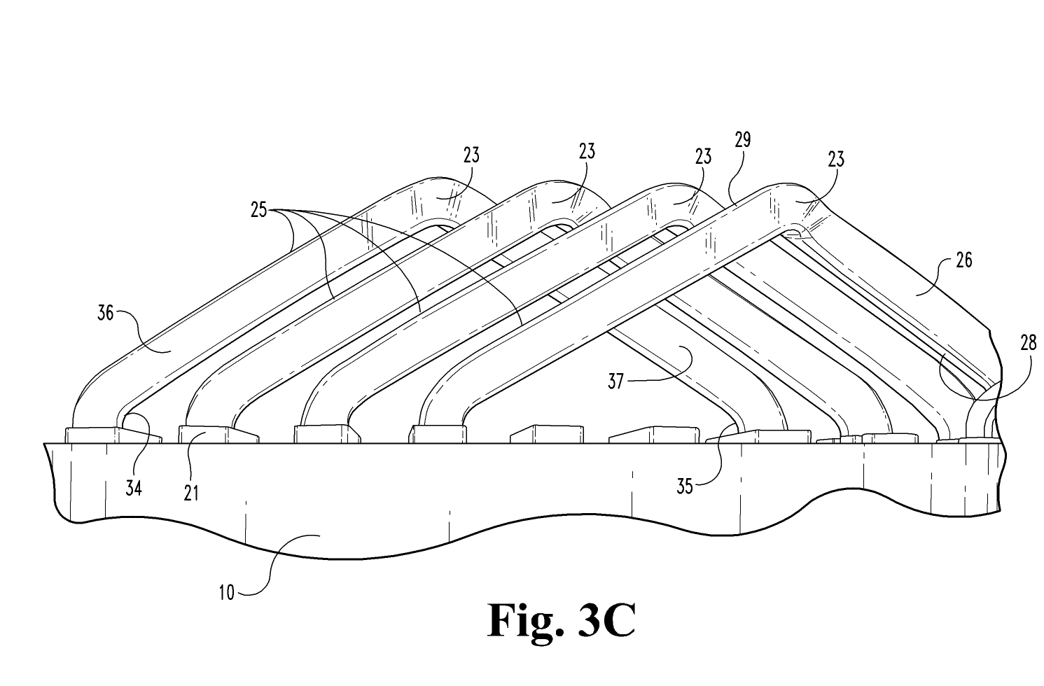

FIG. 2A is a top plan view of an exemplary cylindrical stator body 10 of an electric machine 1, and FIG. 2B is an enlarged portion thereof. For example, stator body 10 may be an iron core fabricated by stacking individual magnetic steel sheet laminates formed by stamping, punching, etching and other processes. A plurality of individual spaced angular portions 11 may be spaced circumferentially at equal intervals about a center axis 9 of stator body 10. One or more conductor passages 13 may be formed along each angular portion 11 to longitudinally extend from each respective slot 14. For example, any appropriate number of individual slots 14 may be radially aligned with one another at a given angular portion 11. As shown, each angular portion 11 has, respecting a radially inward direction, a radially outermost slot position 15, a second radial slot position 16, a third radial slot position 17, a fourth radial slot position 18, a fifth radial slot position 19, and a radially innermost slot position 20. For other illustration purposes, a stator body 10 may have any number of slots for each angular position. Each slot has a sleeve portion 21 axially extending through stator body 10 and outward of the bottom surface (not shown) and top surface 22 of stator body 10. For example, sleeve portion 21 may be formed in a rectangular or other shape and may include material such as inserts and coatings (see, e.g., FIG. 3C). The circumferential interval of adjacent angular portions 11 defines a slot pitch α. Stator body 10 has a radially outward surface 38 and at least one radially inward surface 39 defining a center stator aperture 12.

FIG. 3A is a cross section view of an exemplary conductor bar 24 used for forming stator windings such as those used in a traction motor of an electric vehicle. Conductor bar 24 may be formed of copper, aluminum, or other conductive material. For example, in order to provide a higher output for a given motor size, solid copper wire may be selected because of its excellent conductivity and may have a substantially rectangular cross section, thereby maximizing the amount of copper per unit volume of stator 2. However, when such rectangular wire is used, there is an increased possibility of adjacent conductor bars 24 contacting one another, thereby electrically shorting or otherwise causing physical damage. Reducing the lengths (heights) of stator coil ends while increasing the winding packaging factor of stator 2 may also increase the likelihood of mutual conductor interference. In order to reduce this possibility, for example in a three-phase coil arrangement in a concentric winding form, conductor bars 24 may have selectively bent portions and may be arranged to snugly adjoin one another at locations outside the axial ends of stator body 10 without touching. Conductor bar 24 may have an approximately rectangular profile with two wide surfaces 26, 27, for example 4 mm wide, and two narrow surfaces 28, 29, for example 3 mm wide.

FIG. 3B is a perspective view of an exemplary conductor bar segment 25 having a bent shape for insertion into two slots 14 of stator body 10. A first insertion portion 30 and a second insertion portion 31 extend essentially axially outward from respective distal ends 32, 33 of conductor bar segment 25. Bent portions 34, 35 are respectively formed to define obtuse angles at axially outward ends of insertion portions 30, 31. First and second external portions 36, 37 respectively extend from bent portions 34, 35 and meet to form an obtuse angle defining a center apex portion 23 of conductor segment 25. After being formed into its desired shape, conductor bar segment 25 may be coated with an electrically insulating and/or other protective coating. An individual conductor bar segment 25 may for example be inserted into stator 2 so that an end 32 is placed into a slot 14 at any given radial position 15-20 at a first angular location 11 and an end 33 is placed into a slot 14 at any given radial position 15-20 at a second angular location 11 (see, e.g., FIG. 2A). Depending on a particular application, conductor bar segment 25 may be formed so that insertion portions 30, 31 are essentially parallel and consistently spaced apart, for example by 55 mm. Two conductor bar segments 25 of the same stator coil may be placed into a single slot 14 and inside a single sleeve 21. In some embodiments, conductor bar segments 25 of different stator coils may be placed into the same slot 14.

FIG. 3C is a partial perspective view of an exemplary portion of an axial end of a stator 2, showing bent end portions of adjacent conductor bar segments 25 extending out of stator body 10, with spacing and/or sleeving materials removed for illustration purposes. Conductor bar segments 25 may be shaped so that external portions 36, 37 of a first segment 25 overlap at least a part of external portions 36, 37 of the next sequential segment 25. Alternatively, conductor bar segments 25 may be formed with sequentially differing portions (not shown) such as for a stacking arrangement. For example, separate coils may be formed to have portions axially on top of one another. In various embodiments, conductor bar segments 25 may be shaped to be efficiently compacted by being inserted into selected slots 14 located at different radial positions 15, 16, 17, 18, 19, 20. Individual conductor bar segments 25 are inserted into end sleeve portions 21 until bent portions 34, 35 are proximate the axial end of stator body 10. Typically, the installed conductor bar segments 25 form an essentially uniform annular array about center axis 9 where the respective axially outer surfaces of each apex 23 may be coplanar.

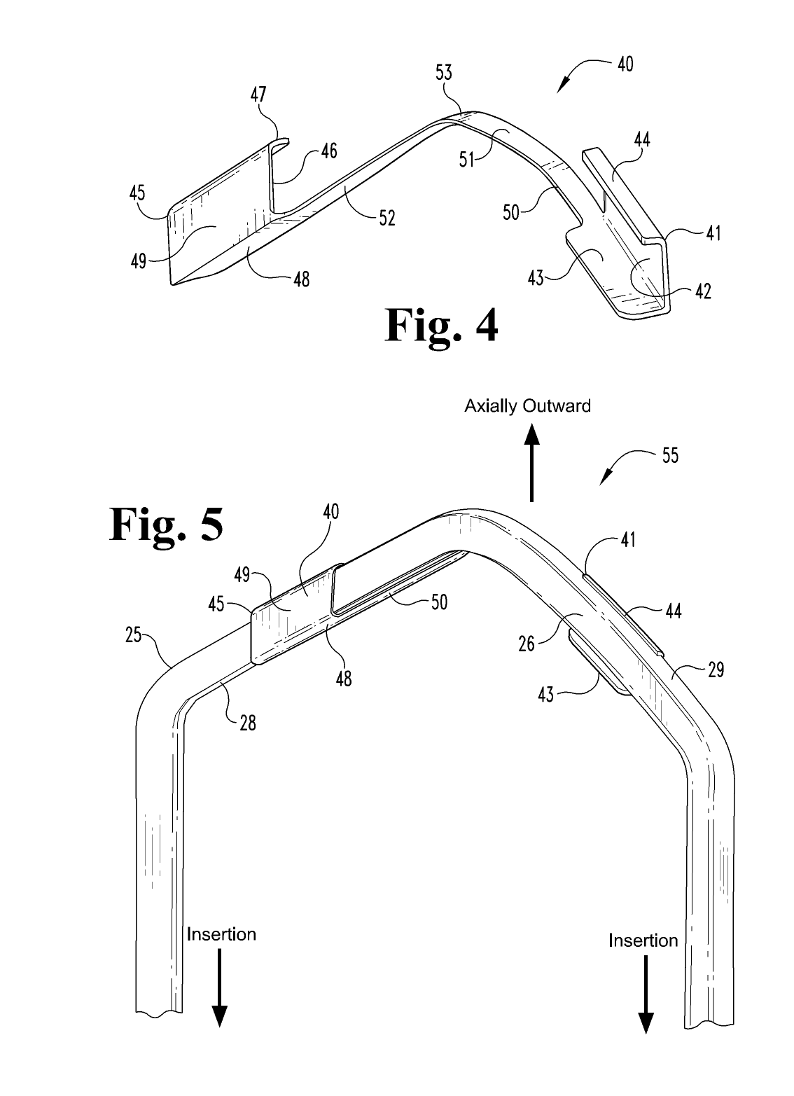

FIG. 4 is perspective view of a conductor spacer clip 40, according to an exemplary embodiment. Conductor spacer clip 40 may be formed, for example, with a plastic or other suitable material having high tensile strength including, but not limited to, Zytel and/or Nylon, and may be injection molded. Plastic spacer clip material may be electrically insulating. A first U-channel portion 41 has an inside bottom surface 42 with a width essentially the same as the width of surfaces 26, 27 of conductor bar 24, for example 4 mm. Opposing side panels 43, 44 of U-channel portion 41 extend away from bottom surface 42 to define an open end of a “U.” Similarly, a second U-channel portion 45 has an inside bottom surface 46 with a width essentially the same as the width of surfaces 26, 27 of conductor bar 24, for example 4 mm. Opposing side panels 47, 48 of U-channel portion 45 extend away from bottom surface 46 to define an open end of a “U.” U-channel portions 41, 45 are connected to one another by a connecting member 50 shown by example as an essentially flat integral extension of both side panel 43 and side panel 48. Connecting member 50 is pre-formed so that an outside bottom surface 49 of U-channel portion 45 faces in a generally same direction as inside bottom surface 42 of U-channel portion 41. Conductor spacer clip 40 may be pre-formed so that the outward facing connecting surface 51 thereof abuts surface 28 of conductor bar segment 25 when conductor spacer clip 40 is clipped onto such conductor bar segment 25. The respective shapes of connecting member 50 and its apex portion 53 are made to approximate the corresponding shapes of conductor bar segment 25 and its apex portion 23 except that such shapes of connecting member 50 are relatively more flattened and generally more obtuse than those of conductor bar segment 25, so that when conductor spacer clip 40 is clipped onto conductor bar segment 25 (see, e.g., FIG. 5), it acts as a spring device that may exert either or both of a tension force and a torsion force, whereby conductor spacer clip 40 urges itself into secure engagement with conductor bar segment 25. Typically, bottom surfaces 42, 45 nominally form a general angle that is more acute compared with a corresponding angle of engagement surfaces 27, 26 of conductor bar segment 25, and surfaces 42, 45 are nominally askew to one another by the twisted shape of spacer clip 40, whereby torsion results when U-channel portion 41 is moved relatively clockwise (CW) and U-channel portion 45 is moved relatively counter-clockwise (CCW). In other words, when such nominal shape is changed by attaching conductor spacer clip 40 to conductor bar segment 25, the change effects torsion. In the example of FIG. 4, when conductor spacer clip 40 is clipped on, first U-channel portion 41 is thereby moved CW while second U-channel portion 45 is moved CCW. After being clipped on, the resultant torsion urges first U-channel portion CCW while urging second U-channel portion 45 CW, and while urging apex portion 53 in a generally axially outward direction by the spring force. Side panels 43, 44 of U-channel portion 41 and side panels 48, 47 of U-channel portion 45 are typically formed to assure a snug fit against respective surfaces 28, 29. Connecting member 50 may exert/transfer tension and/or torsion as a biasing member. Connecting member 50 has a surface 52 facing the interior of an angle formed at apex 53.

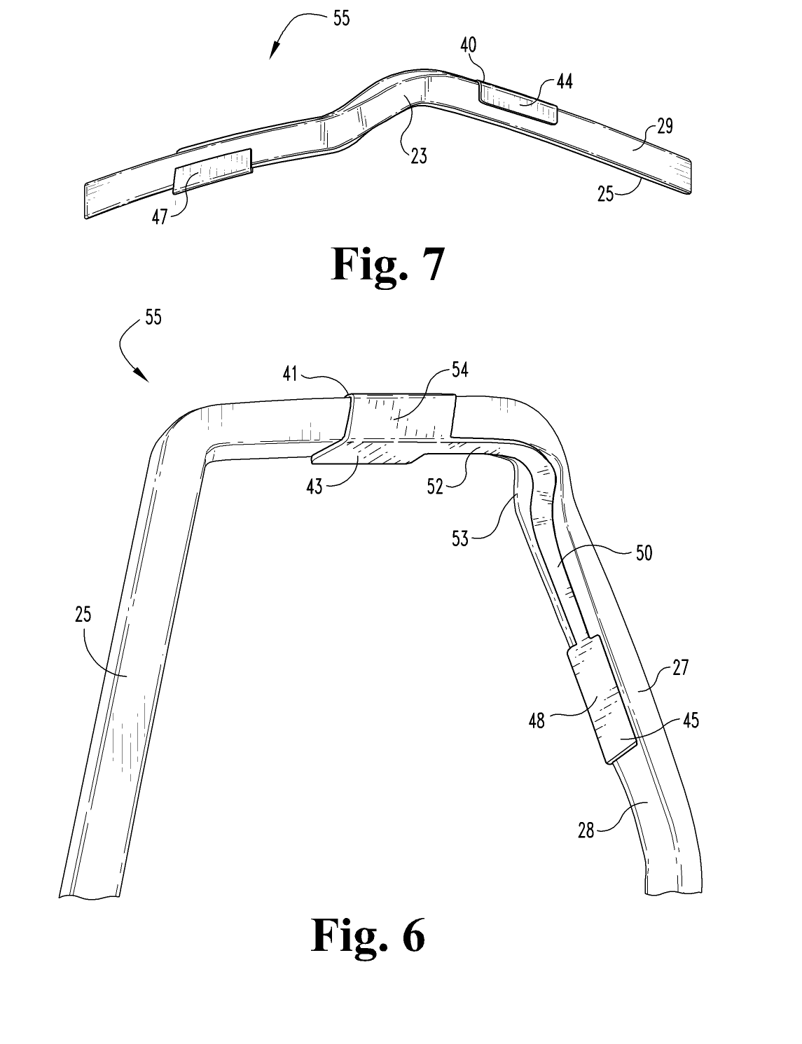

FIG. 5 and FIG. 6 are respective front and rear partial perspective views of a pre-insertion assembly 55 that includes a conductor spacer clip 40 clipped onto a conductor bar segment 25. For example, conductor spacer clip 40 is twisted slightly and locks itself onto conductor bar segment 25. When assembly 55 is being inserted into appropriate slots 14 of stator body 10, assembly 55 may inadvertently come into contact with an adjacent conductor bar segment 25, spacer clip 40, or other structure. In such a case, it is desirable for conductor spacer clip 40 to resist being dislodged or moved in a generally axially outward direction. Accordingly, connecting member 50 and side panels 43, 48 are prevented from being moved axially outward by their respective abutment with conductor surface 28. Such abutment may be continuous or nearly so between distal ends of conductor spacer clip 40. The axially inward surface 52 of connecting member 50 and the external surfaces of side panels 43, 48 provide spacing that prevents any axially inward structure such as an adjacent segment from contacting any exposed metal of conductor bar segment 25. Similarly, external surface 54 of U-channel portion 41 acts as a spacer that prevents lateral electrical contact with conductor surface 26 of an adjacent conductor bar and external surface 49 of U-channel portion 45 acts as a spacer that prevents lateral contact with conductor surface 27 of an adjacent conductor bar. By utilizing a spacer clip that places spacer material on only one conductor bar at an interface of two adjacent conductor bars, the amount of volume occupied by spacer material is reduced. By utilizing a structure of opposed U-channel portions, a self-secured spacer clip prevents conductor bar misalignment and damage, and prevents displacement of and damage to the spacer clip due to axial installation of individual conductor bar segments. Electrical shorting is thereby prevented while minimizing spacer volume and while preventing displacement of conductor spacer clips 40 during assembly. Typically, there may be little need to place spacer material along the axially outward surface 29 of conductor bar segment 25. Accordingly, the respective heights of side panels 44, 47 may be provided to assure adequate engagement and alignment of U-channel portions 41, 45 with conductor bar 24, but it is not required in various embodiments that side panels 44, 47 extend further across surface 29. The twisting torsion exerted by a clipped-on conductor spacer clip 40 compels the apex portion 53 thereof toward the apex 23 of conductor bar segment 25.

FIG. 7 is a partial top perspective view of pre-insertion assembly 55. The heights of respective side panels 44, 47 extend across portions of conductor bar surface 29 to assure that conductor spacer clip 40 is securely held onto conductor bar segment 25. Otherwise, as noted above, the axially outer portion of surface 29 may be unlikely to come in contact with electrically conductive material and may be unlikely to incur damage during a stator manufacturing process after being assembled and coated. In such a case, the minimization of spacer materials allows for more space to be utilized for cooling purposes and/or for reducing the relative size of an electric machine 1. In many applications, for example, the spacer clip insulating and protecting portion of primary interest may be in a given portion of connecting member 50, where U-channel portions 41, 45 operate to hold connecting member 50 properly in place. In many cases, such as when a number of conductors 24 are stacked in layers or otherwise configured in close proximity to one another, the apex portion 23 must be spaced apart, insulated, and protected from damage in the axial direction. So long as there exist at least one layer of plastic or other suitable spacer clip material between “active” portions of adjacent conductors 24, an adequate barrier is thereby provided. By having a small footprint, for example, by covering only a portion of one side 28 of conductor bar segment 25, connecting member 50 thereby minimizes heat retention of conductor segment 25. Physical spacing and electrical insulation may be achieved while maximizing the heat transfer out of apex portion 23 of conductor segment 25.

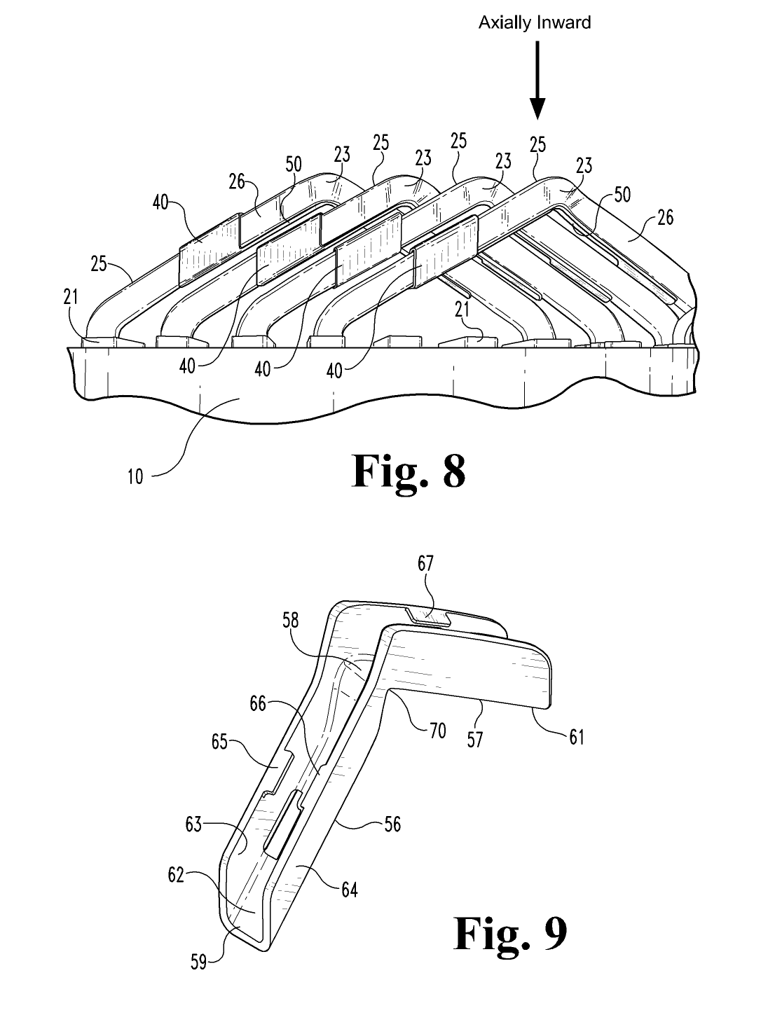

FIG. 8 is a partial perspective view of an exemplary array of conductor bar segments 25 each having a conductor spacer clip 40 clipped thereon, and each being installed into stator body 10. A given electric machine 1 may have groups of individual conductors, for example four conductors in the stator of a three-phase traction motor for an electric or hybrid vehicle, two conductors in the stator of an automotive alternator, etc. A given conductor bar segment 25 may have only one adjacent conductor or it may have multiple adjacent conductors. In an exemplary stator manufacturing process, each pre-insertion assembly 55 (e.g., FIG. 5) is assembled and placed onto a carrier (not shown) that is positioned in proximity to a stator body 10. Conductor bar ends 32, 33 of individual assemblies 55 are then inserted into selected end sleeve portions 21 of slot liners that may extend through stator body 10. Alternatively, portions of conductor bar segment 25 may be coated with insulation prior to assembly in order to eliminate the need for slot liners. Each individual assembly 55 is pushed in an axially inward direction for only approximately one inch, and then a sequentially next assembly 55 is inserted and pushed axially inwardly for an inch, until all assemblies 55 have been inserted into respective conductor passages 13 (e.g., FIG. 2A). The orientation and structure of conductor spacer clip 40 assures that the axial pressing of clipped conductor segments 25 does not dislodge such spacer clip 40. After stator body 10 has been populated with all assemblies 55, assemblies 55 are then simultaneously pressed axially inward until every conductor bar segment 25 is positioned into its final resting position. For example, a press or other urging device may have rubber or other non-abrasive surfaces that engage respective portions on surface 29 and/or on side panels 44, 47 (e.g., FIG. 7) of each conductor bar segment 25 for pushing each segment 25 in the axially inward direction. The conductor spacer clips 40 prevent individual conductors 25 from contacting adjacent conductors 25 during this installation process. Such conductor to conductor contact can otherwise compromise and damage the insulation materials previously coated onto the conductor bar segments 25. Adjacent conductor spacer clips 40 may be configured to provide support to one another during the axially inward insertion, so that the adjacent spacer clips 40 hold each other in position and prevent each other from becoming dislodged. The cooperation between adjacent assemblies 55 being installed may also retain and/or prevent damage to ancillary structure such as phase insulation materials. After insertion, portions of conductor bar segments 25 that protrude outside stator body 10 (e.g., external portions 36, 37 and apex 23, shown in FIG. 3B) may be referred to as “end turns.”

In various embodiments, conductor spacer clips 40 may be installed onto respective conductor bar segments 25 at any time during stator assembly. For example, a small spacer clip 40 may be picked concurrently with the picking of an individual conductor bar segment 25 and may be quickly snapped into position before such segment 25 is inserted into appropriate end sleeve portions 21, whereby the manufacturing time is minimally affected by clipping the conductor spacer clip 40 onto conductor bar segment 25. In a subsequent twisting operation, respective conductor bar ends 32, 33 (e.g., FIG. 3B) protruding out of the other axial end of stator body 10 may be twisted to their final position and welded. Various processes for connecting conductor ends to one another include, but are not limited to, TIG welding, plasma welding, resistance welding, fusing, fusing type brazing, and resistance type brazing. A varnishing (e.g., VPI) operation may be performed at any point in the stator manufacturing process. For example, when correct placement, spacing, bending, welding and other operations have been verified and conductor to conductor separation has been maintained throughout the entire process, such varnishing may be optimized for the particular manufacture while assuring the prevention of damage to the conductors and associated coatings. In various embodiments, multiple conductor spacer clips 40 may be simultaneously clipped onto respective ones of a plurality of conductor bar segments 25 prior to pressing the conductor array into its final resting position. In various embodiments, conductor segment 25 may be passed through a spacer clip carrier (not shown) as it is being installed into a stator body 10, whereby a conductor spacer clip 40 is installed onto the conductor segment 25 being installed, thereby combining the clipping and inserting process steps.

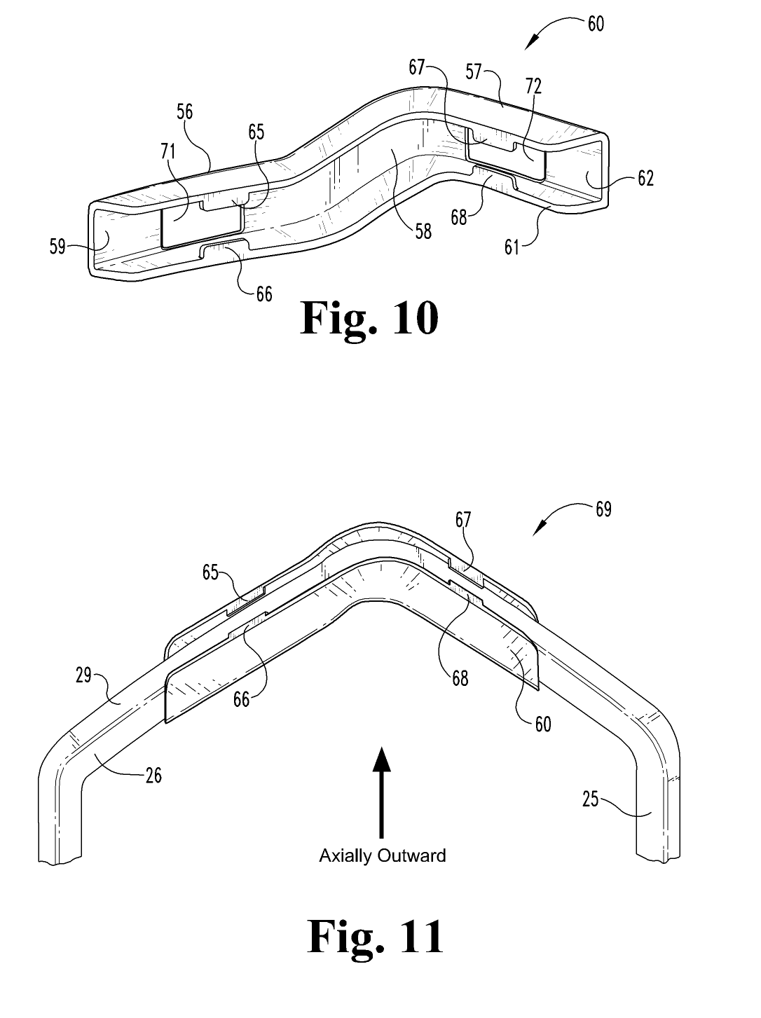

FIG. 9 and FIG. 10 are perspective views of a conductor spacer clip 60, according to an exemplary embodiment. Conductor spacer clip 60 may be formed, for example, with a plastic or other suitable material having high tensile strength including, but not limited to, Zytel and/or Nylon, and may be injection molded. Alternatively, conductor spacer clip 60 may be formed, for example, of various materials having low tensile strength and high compressive strength. A U-channel 61 is adapted for being snapped onto a portion of conductor bar segment 25 that includes apex 23 (e.g., FIG. 3B). U-channel 61 has a bottom portion 59 with an inside bottom surface 62 having a width essentially the same as the width of surfaces 26, 27 of conductor bar 24, for example 4 mm. Opposing side panels 63, 64 of U-channel portion 61 extend away from bottom surface 62 to define an open end of a “U.” Conductor spacer clip 60 may be formed so that inside bottom surface 62 has the same shape as surface 28 of conductor bar segment 25, so that when conductor spacer clip 60 is attached to the portion of conductor segment 25 that includes apex 23, clip 60 is not thereby tensioned. In such a case, linearly extending portions 56, 57 and twisted portion 58 of conductor spacer clip 60 may be nominally shaped to respectively abut surface 28 along all or a portion of inside bottom surface 62. A twisted apex 70 is thereby defined in twisted portion 58. However, the shape of conductor spacer clip 60 may be modified to exert self-holding tension and/or torsion in a manner similar to that described above for conductor spacer clip 40. Conductor spacer clip 60 includes opposed tabs 65, 66 extending toward one another from respective opposed side panels 63, 64. When the distance along each respective side panel from inside bottom surface 62 to tabs 65, 66 approximates the width of surfaces 28, 29 of conductor bar 24, for example 3 mm, conductor spacer clip 60 may be clipped onto conductor bar segment 25 so that clip 60 is securely held thereon by engagement of tabs 65, 66 with outward facing surface 29 of segment 25, as shown by example in FIGS. 11-13. Conductor spacer clip 60 also includes opposed tabs 67, 68 extending toward one another from respective opposed side panels 63, 64. Typically, the distance along each respective side panel from inside bottom surface 62 to tabs 67, 68 also approximates the width of surfaces 28, 29 of conductor bar 24, for example 3 mm, so that when conductor spacer clip 60 is clipped onto conductor bar segment 25, clip 60 is also securely held thereon by engagement of tabs 67, 68 with outward facing surface 29 of segment 25. When, for example, conductor spacer clip is formed by an injection molding process, a first rectangular aperture 71 may be formed along bottom portion 59 to facilitate the formation of tabs 65, 66, and a second rectangular aperture 72 may be formed along bottom portion 59 to facilitate the formation of tabs 67, 68.

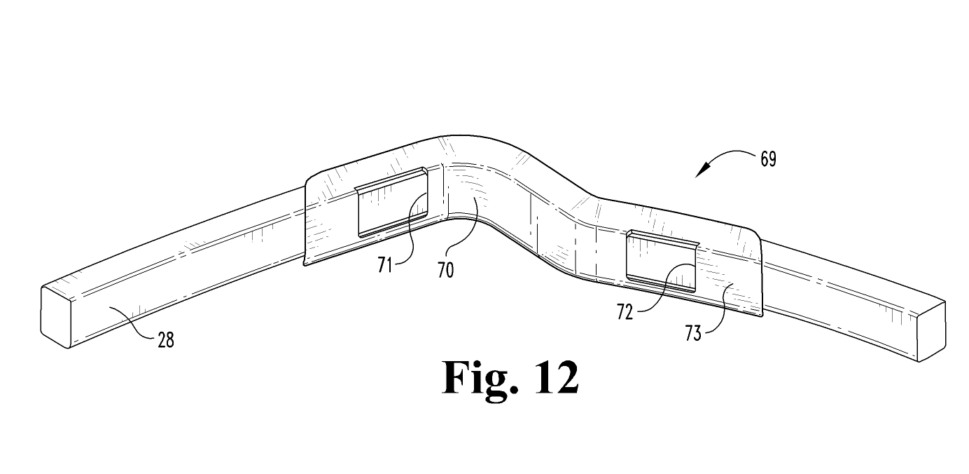

FIG. 11 and FIG. 12 are partial perspective views of a pre-insertion assembly 69 that includes a conductor spacer clip 60 clipped onto a conductor bar segment 25. As described above for conductor spacer clip 40, it is desirable for conductor spacer clip 60 to resist being dislodged or moved in a generally axially outward direction when assembly 69 is being inserted into conductor passages 13 of stator body 10. Accordingly, conductor spacer clip 60 is prevented from being moved axially outward by the abutment of inside bottom surface 62 with axially inward conductor surface 28. Such abutment may be continuous or nearly so between distal ends of conductor spacer clip 60. The external surface 73 of bottom portion 59 provides spacing that prevents any axially inward structure such as an adjacent conductor bar from contacting any exposed metal of conductor bar segment 25. Similarly, side panels 63, 64 act as spacers that prevent lateral electrical contact with conductor surfaces 26, 27 of adjacent conductor bars. Electrical shorting and displacement of conductor spacer clips 60 during assembly are thereby each prevented. Typically, as discussed above, there may be little need to place spacer material along the axially outward surface 29 of conductor bar segment 25 and, accordingly, a relatively small amount of spacer material may be used in forming tabs 65-68. As a result, nearly all of surface 29 may be exposed, thereby facilitating heat transfer while assuring proper conductor spacing. For a given design, portions of conductor spacer clip 60 may be removed to provide additional heat transfer.

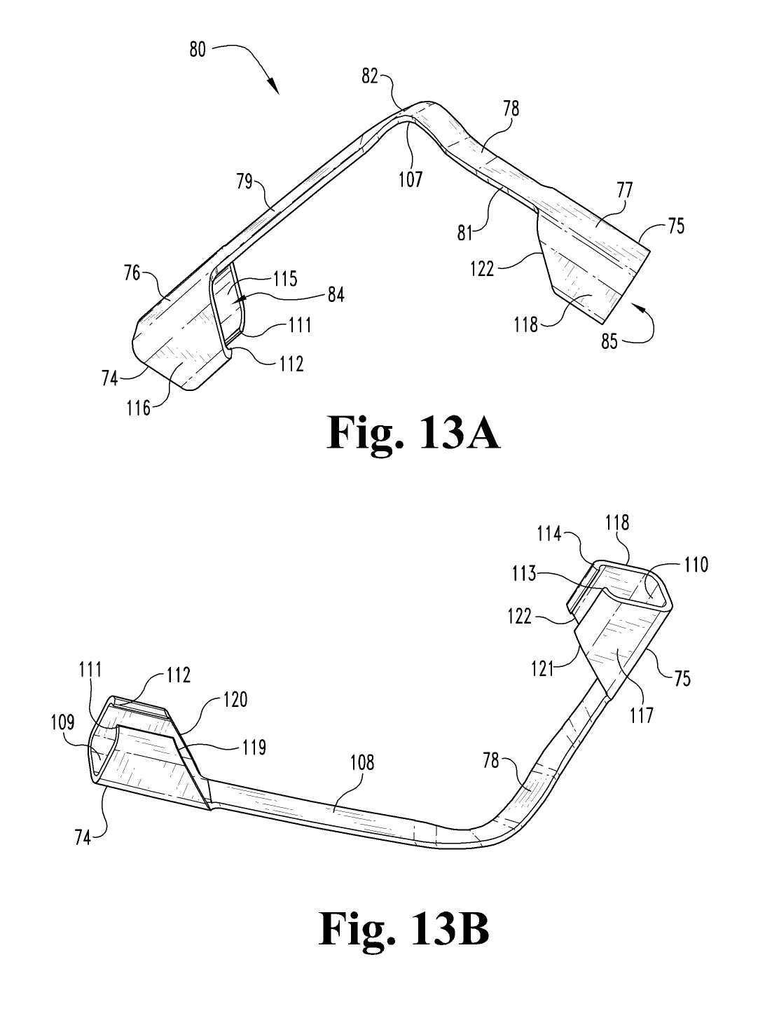

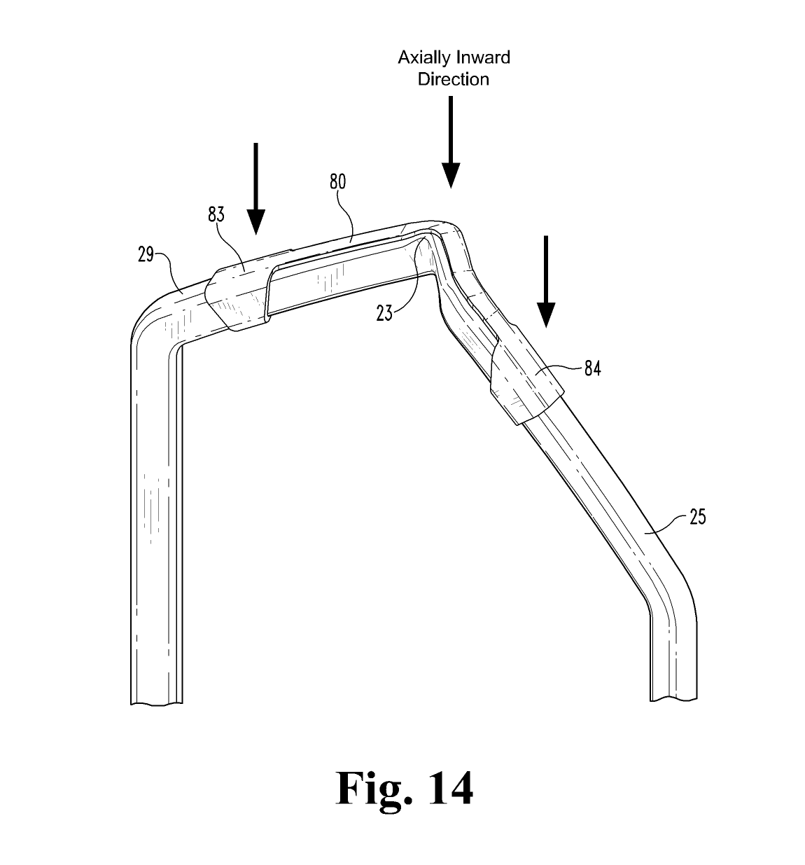

FIG. 13A and FIG. 13B are perspective views of a conductor spacer clip 80, according to an exemplary embodiment. Conductor spacer clip 80 may be formed in a manner generally as described above for spacer clips 40, 60, for example, by injection molding with a plastic or other suitable material having high tensile strength including, but not limited to, Zytel and/or Nylon. Conductor spacer clip 80 has a first U-channel portion 74 and a second U-channel portion 75, with respective bottom portions 76, 77 being joined to one another via a connecting member 78. Connecting member 78 has a linear portion 79 and a linear portion 81 coupled to one another by a twisted portion 82. Conductor spacer clip 80 may be formed so that the interior spaces 84, 85 of respective U-channel portions 74, 75 are approximately the same shape as the cross sectional profile of conductor 24 shown by example in FIG. 3A, for example 3 mm×4 mm. Conductor spacer clip 80 is adapted for being snapped onto a portion of conductor bar segment 25 that includes apex 23, as shown by example in FIG. 14. A press or other urging force may contact respective exterior locations 83, 84 of bottom portions 76, 77 whereby spacer clip 80 is clipped onto conductor bar segment 25. This prevents the tooling from coming into contact with conductor bar segment 25, whereby abrasion or other damage is prevented. When clipped onto conductor bar segment 25, the inward surface 108 of connecting member 78 and the respective interior surfaces 109, 110 of U-channel portions 74, 75 abut surface 29 of conductor segment 25. Conductor spacer clip 80 includes opposed tabs 111, 112 extending toward one another from respective opposed side panels 115, 116 of U-channel portion 74. Conductor spacer clip 80 also includes opposed tabs 113, 114 extending toward one another from respective opposed side panels 117, 118. In a manner similar to that described above (e.g., FIG. 9), tabs 111-114 securely hold conductor spacer clip 80 onto conductor segment 25. In addition, tabs 111-114 may have a rounded profile and a short extension length across the respective open ends of the “U” shape, so that when spacer clip 80 is being pressed onto conductor segment 25, such engagement compels the respective opposed side panels 115, 116 and 117, 118 away from one another to allow the conductor segment 25 to enter respective interior spaces 84, 85 more easily. When entry is complete, tab portions 111-114 snap back into a nominal position abutting surface 28 of conductor segment 25 (e.g., FIG. 3A). Further, U-channel portions 74, 75 typically have respective opposed beveled edges 119, 120 and 121, 122 formed respectively on side panel pairs 115, 116 and 117, 118. For example, bevels 119-122 may provide the necessary space required for forming tabs 111-114 during an injection molding process. In another example, such bevels 119-122 may provide spacing in selected portions of U-channels 74, 75 adjacent to connecting member 78 while minimizing the amount of spacer material being used for temporarily holding spacer clip 80 adequately in place during the various stator assembly processes.

Conductor spacer clip 80 may be nominally shaped to match a corresponding shape of surface 29 of conductor bar segment 25, or it may be formed to exert self-holding tension and/or torsion when clipped on, in a manner similar to that described above for conductor spacer clip 40. When conductor spacer clip 80 is attached to conductor bar segment 25, as shown in FIG. 14, it protects surface 29 against impact being imparted in the axially inward direction and thereby prevents damage to conductor bar segment 25. Conductor spacer clip 80 may be implemented in a small size while providing adequate spacing away from adjacent conductor segments 25 and other structure.

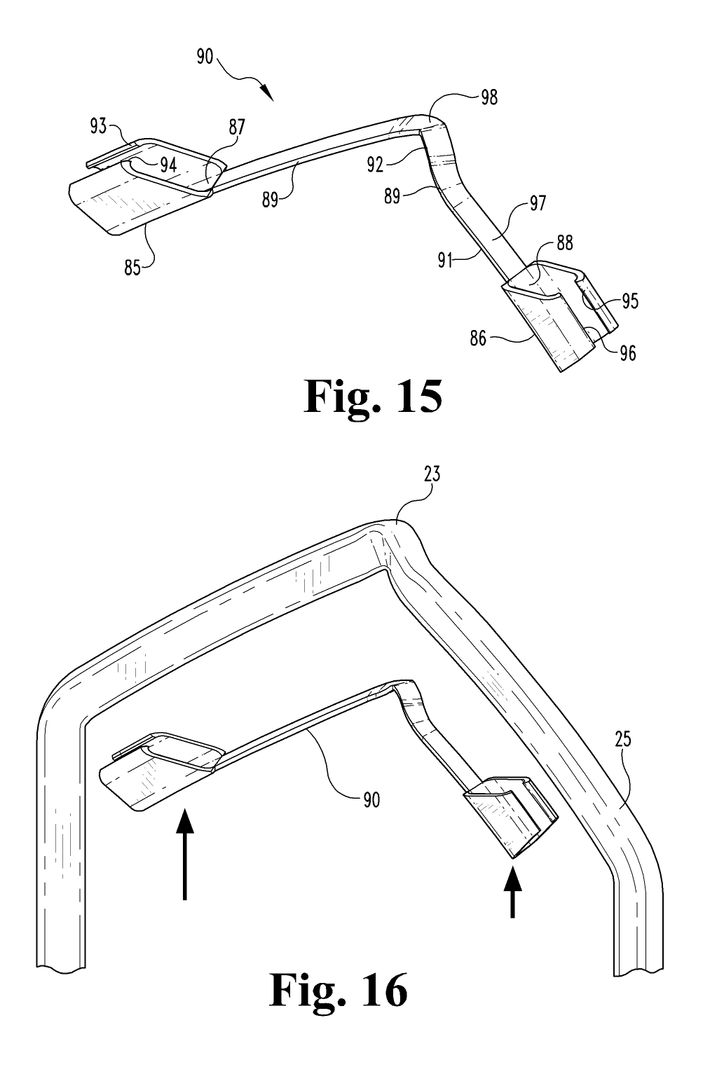

FIG. 15 is a perspective view of a conductor spacer clip 90, according to an exemplary embodiment. Conductor spacer clip 90 may be formed in a manner generally as described above for spacer clips 40, 60, 80 for example, by injection molding with a plastic or other suitable material having high tensile strength including, but not limited to, Zytel and/or Nylon. Conductor spacer clip 90 has a first U-channel portion 85 and a second U-channel portion 86, with respective bottom portions 87, 88 being joined to one another via a connecting member 89. Connecting member 89 has linear portions 89, 91 coupled to one another by a twisted portion 92. U-channel portions 85, 86 are typically formed so that each encloses a space having a cross sectional profile that is approximately the same shape as the cross sectional profile of conductor 24 shown by example in FIG. 3A, for example 3 mm×4 mm. Conductor spacer clip 90 is adapted for being snapped onto a portion of conductor bar segment 25 that includes apex 23, as shown by example in FIG. 16. A press or other urging force may contact the exterior of respective U-channel portions 85, 86, whereby spacer clip 90 is clipped onto conductor bar segment 25. Opposed tabs 93, 94 extend toward one another from opposite sides of the “U” of U-channel portion 85 and are formed to spread the “U” apart when being pressed onto conductor bar segment 25, and then snap back toward their nominal position to thereby secure spacer clip 90 to conductor segment 25. Opposed tabs 95, 96 extend toward one another from opposite sides of the “U” of U-channel portion 86 and are formed to spread the “U” apart when being pressed onto conductor bar segment 25, and then snap back toward their nominal position to thereby secure spacer clip 90 to conductor segment 25. Conductor spacer clip 90 may be nominally shaped so that mating surface 97 abuts surface 28 (see, e.g., FIG. 3A) of conductor segment 25 along all or a portion thereof, whereby an apex portion 98 of spacer clip 90 is in close proximity to apex portion 23 of conductor segment 25. Conductor spacer clip 90 may be nominally shaped to match a corresponding shape of surface 28 of conductor bar segment 25, or it may be formed to exert self-holding tension and/or torsion when clipped on, in a manner similar to that described above for conductor spacer clip 40.

In various embodiments, conductor spacer clips 40, 60, 80, 90 may be installed onto conductor bar segments 25 individually by hand or they may be formed as multiple clips in a cartridge of an automated tool (not shown) that feeds individual clips 40, 60, 80, 90 to an insertion head. In various embodiments, multiple conductor spacer clips 40, 60, 80, 90 may be installed in groups. For example, conductor spacer clips 40, 60, 80, 90 may be ganged together so that they may be subsequently broken apart at a plastic seam (not shown) connecting adjacent clips 40, 60, 80, 90. Typically, break points and seams are located at portion(s) of conductor spacer clip 40, 60, 80, 90 that are not critical to functionality and that facilitate installation and assembly. In various embodiments, apertures 71, 72 may provide grasping locations adapted for engagement with a clip installation tool (not shown) that subsequently places and/or presses a spacer clip 60 onto a conductor bar segment 25. For example, the tool may engage spacer clip 60 along perimeters of apertures 71, 72 so that one or more conductor spacer clips 60 may be picked up off of a parts carrier (not shown) in a process of forming pre-insertion assembly 69. In another example, the clip installation tool may secure an individual spacer clip 40, 60, 80, 90 being sheared away from a ganged or daisy-chained array of respective spacer clips 40, 60, 80, 90 by such grasping or engagement in perimeter areas of apertures 71, 72. In a further example, an array of ganged spacer clips 60 may be grasped in perimeter areas of apertures 71, 72 for subsequent placement of the array onto a corresponding array of conductor bar segments 25. In yet another example, a cartridge (not shown) containing a quantity of conductor spacer clips may be provided to a feed mechanism that grasps a perimeter portion of an aperture 71, 72 for feeding an individual conductor spacer clip 60 from the cartridge into a dispensing location for subsequent placement onto conductor segment 25.

In a further example, break points and seams may be formed on conductor spacer clips 40, 60, 80, 90 to provide temporary holding of U-channel portions 41, 45, 74, 75, 85, 86 during assembly. In particular, in some applications, pairs of such U-channel portions 41, 45, 74, 75, 85, 86 may be utilized for spacing conductor bar segments 25 apart from one another near apex portions 23, without the need for connecting portions. In an exemplary embodiment, break seams may be provided at the junctions of U-channel portions 74, 75 and connecting member 78 (e.g., FIG. 13A) so that a conductor spacer clip 80 may be installed in a single axial motion, and then connecting member 78 may be broken off, leaving only U-channel pair 74, 75 accurately positioned for preventing adjacent conductor bar segments 25 from touching one another. An assembly of an electric machine may thereby include a plurality of conductor spacer clips each having a pair of channel members 74, 75 attached to respective ones of the conductor segments 25 proximate the respective turn portions, where the attached channel member pairs 74, 75 space adjacent ones of the conductor segments 25, and where the channel member pairs 74, 75 prevent adjacent ones of the conductor segments 25 from contacting one another. The thickness of each channel member 74, 75may be made larger to accommodate more spacing for conductor segments 25 having differing profiles. For example, when the bend shape of adjacent conductor segments 25 varies because of manufacturing tolerances, slight bending due to insertion forces, and/or densely populated end turn space, such conductor segments 25 may be adequately spaced by increasing the thickness of U-channel portions 74, 75. When the thicknesses of U-channel portions 74, 75 is made smaller, the conductor bar segment profiles must be kept within a tighter tolerance to assure adequate spacing.

The general concepts described herein may be implemented by providing different conductor spacer clips, for example, for different conductor 24 cross sectional size and/or for different stator 2 size.

In an exemplary application, electric machine 1 may be a traction motor of an electric vehicle such as a hybrid automobile. The traction motor may be adapted to circulate a coolant. For example, oil may be circulated around the outside diameter of a stator 2 by use of a cooling jacket (not shown), and the oil may be sprayed directly onto the end turns that protrude from stator body 10, whereby the end turns are bathed in oil. As a result, the oil absorbs heat from the conductors 25 directly at the heat source. The heated oil circulates out of the motor to a cooling system or heat exchanger (not shown), such as a radiator-type oil cooler that extracts heat from the oil, whereupon the cooled oil is returned back to the motor. In another example of cooling a traction motor, a potting material is utilized in a water-cooled electric machine 1. Typically, a water jacket (not shown) circumscribes the stator assembly 2. The heat generation and losses in the end turn portion of stator windings 3 are more easily transferred out of the end turns and into the water when selected portions of such end turns are potted with a potting material having a high thermal conductivity. For example, epoxy materials and/or silicon based materials may be used for potting the end turns and creating conduit(s) with a higher thermal conductivity than air for transferring heat from conductors 25 through the potting medium via the conduits into an aluminum housing 8 (e.g., FIG. 1) and into the water. By use of small, efficient conductor spacer clips 40, 60, 80, 90, the conductor surface area being utilized for spacing adjacent conductor segments 25 is minimized, whereby more conductor surface area remains for effecting heat transfer of end turn portions. Depending on the particular application, conductor spacer clips 40, 60, 80, 90 may be installed on every conductor bar segment 25, on every other conductor bar segment 25 (alternating pattern), or on selected conductor bar segments 25 of a stator assembly 2. A single U-channel portion may be provided at any location of a conductor segment 25 for spacing such segment away from any adjacent conductor segment 25.

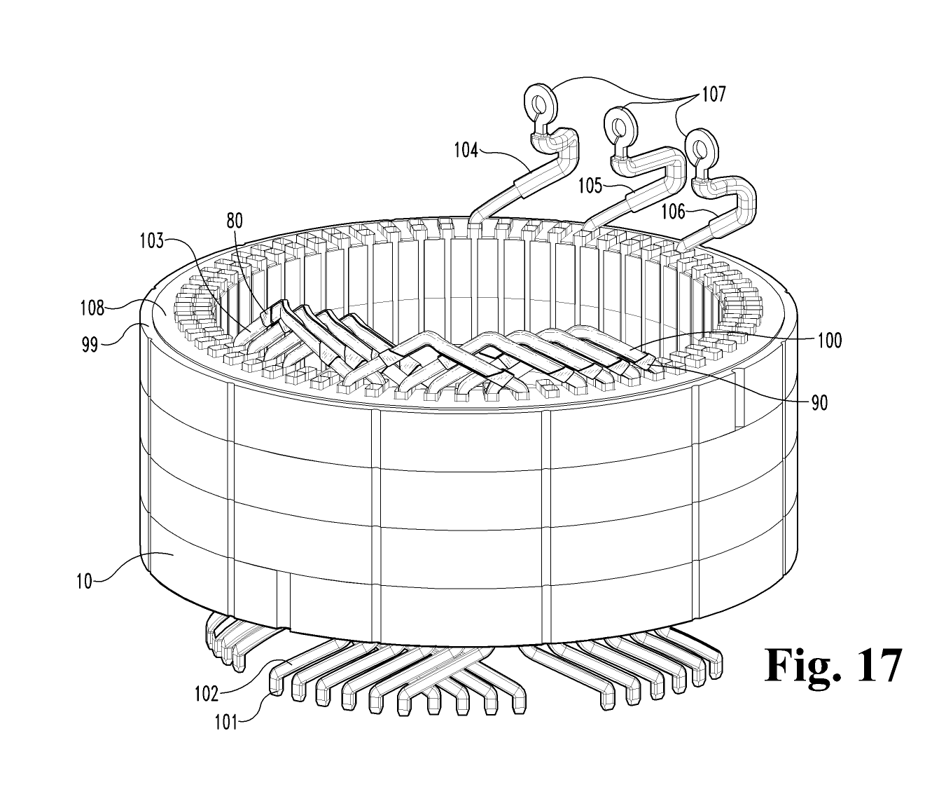

FIG. 17 is a partial perspective view of an assembled stator according to an exemplary embodiment, where most of the array of conductors has been removed for illustration purposes. A stack of laminations 99 enclose insulating sleeve portions 21 which protrude from each axial end of stator body 10 at conductor passages 13. Outside conductor bar segments 100 are shaped and coated with one or more layers of coating material 102 for insulating, abrasion-resistance, sealing, lubricating, and/or other appropriate reason, except at respective conductor segment ends 101. A conductor spacer clip 90 is attached to each outside conductor segment 100, which are then each inserted into selected ones of conductor passages 13. Inside conductor bar segments 103 are shaped and coated with one or more layers of coating material 102 for insulating, abrasion-resistance, sealing, lubricating, and/or other appropriate reason, except at respective conductor segment ends 101. A conductor spacer clip 80 is attached to each inside conductor segment 103, which are then each inserted into selected ones of conductor passages 13. Slot liners (not shown) are typically installed in conductor passages 13. Insulated phase coil wires 104, 105, 106 are fed through or around stator body 10 and respectively terminated using ring terminals 107. When all segments 100, 103 have been inserted and stator body 10 is fully populated, and when the apex portions 23 of conductor segments 100 and the apex portions 107 of conductor spacer clips 80 have been properly placed, for example by pressing the assembly into a mold until all structure is correctly seated, the ends 101 of conductor segments 100, 103 are further shaped in a twisting operation, and then welded, brazed, or otherwise processed for electrically connecting conductor segments 100, 103, phase coil termination wires 104, 105, 106, and any other ancillary electrical device in accordance with the electrical circuit embodied by stator 2. Additional conductor spacer clips (not shown) may be provided for portions of conductor bar segments 25 at the axial end of stator 2 adjacent conductor ends 101, in accordance with the general principles described herein for spacing apex portions of such conductor bar segments 25. A potting material 108 may be poured into stator body 10 to solidify the structure and optimize its thermal characteristics. Such potting is typically performed only in selected areas of an interior portion of stator body 10, for example to expose external un-potted end turn portions to a coolant.

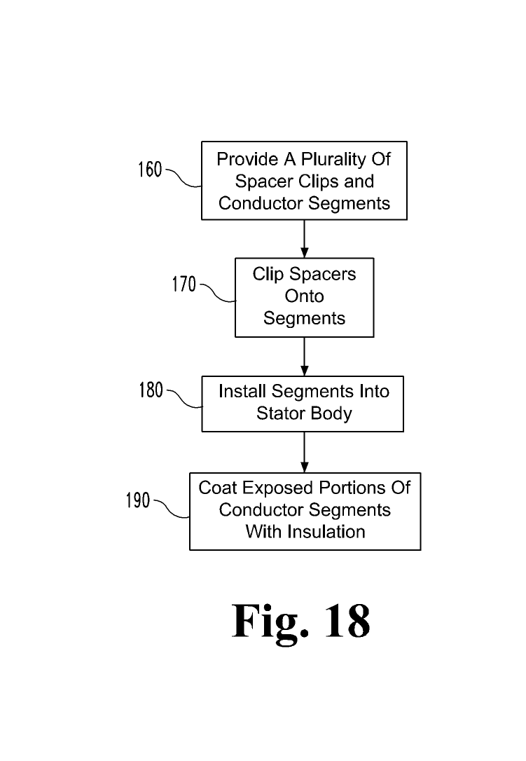

In various embodiments, various processes may be used for connecting conductor ends to one another, as described above, and any number of varnishing or other coating operations may be performed at any point in the stator manufacturing process. For example, the use of conductor spacer clips improves the accuracy and verification of the various placing, spacing, bending, welding and other operations throughout the entire process, thereby optimizing productivity while assuring the prevention of damage to the conductors and associated coatings. An exemplary stator manufacturing method is shown in FIG. 18. In step 160, a plurality of conductor spacer clips and a corresponding plurality of conductor bar segments are provided to a stator manufacturing area. In step 170, individual ones of the conductor spacer clips are clipped onto individual conductor bar segments. For example, conductor segments each having a spacer clip are provided as pre-insertion assemblies. In step 180, the “clipped” conductor segments are installed into a stator body, such as by being inserted into insulated conductor passages extending through the stator body, until all clipped conductor segments are inserted and the stator body is fully populated. In step 190, the exposed conductors of the populated stator body are coated with insulation, whereby the spacers cause the insulation coating to insulate the exposed conductors from one another. For example, the exposed end turns may be varnished after all conductor segments are fully seated and spaced apart by the conductor spacer clips. As a result, the amount of insulation may be optimized for providing inter-conductor insulation while minimizing insulation volume in order to maximize heat transfer in the end turn portion of a stator. Each conductor bar segment 25 may thereby have a discrete electrically insulative outer layer so that end turns of a stator 2 are not insulated by a single monolithic mass of insulative material that envelops multiple end turns.

Although many electric machines operate at very high efficiencies, some energy is necessarily lost. Such energy losses take various forms including friction losses, core losses and hysteresis losses, and result in the generation of waste heat. In some applications, heat must be actively removed from the electric machine to prevent this waste heat from reaching impermissible levels in the windings of the electric machine. Spray cooling typically involves spraying oil on the end windings to remove heat. By reducing the space required for conductor spacing in the end windings, the exemplary conductor spacer clip embodiments enable more efficient removal of such heat from end turns. In various embodiments, the various exemplary features of any of the conductor spacer clips described herein may be combined with one another according to a given conductor spacing application.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An assembly of an electric machine, comprising:
a plurality of conductor segments each having a turn portion; and
a plurality of clips each having a channel member and a bend member, the channel members being attached to respective ones of the conductor segments and thereby holding the respective bend members against the respective turn portions;
wherein the attached clips space adjacent ones of the conductor segments, and wherein the bend members prevent adjacent ones of the conductor segments from contacting one another.

2. The assembly of claim 1, wherein each conductor segment has a rectangular profile, and wherein the bend member covers only a portion of one side of the conductor segment.

3. The assembly of claim 1, wherein the bend member is substantially flat.

4. The assembly of claim 1, wherein the bend member substantially conforms to the shape of the conductor turn portion.

5. The assembly of claim 1, wherein each channel member comprises a pair of channel members connected by the bend member.

6. The assembly of claim 5, wherein the pair of channel members are rotationally biased relative to one another, thereby effecting a clip-holding mechanism.

7. The assembly of claim 1, wherein the plurality of clips are configured as an array of ganged components including at least one breakable gang member coupling adjacent ones of the components to one another.

8. The array according to claim 7, wherein the plurality of clips are formed as a cartridge, and wherein the at least one breakable gang member comprises an adhesive or a seam integrally formed with the components.

9. The assembly of claim 1, wherein the plurality of clips are snap fit onto the conductor segments.

10. A method of constructing a coil of an electric machine, comprising:
providing a plurality of conductor segments having respective turn portions;
providing a plurality of clips each having a channel member and a bend member extending from the channel member;
attaching the clips to respective turn portions of the conductor segments; and
installing the clipped conductor segments into a coil containment structure, and using the bend members of the clips to prevent adjacent ones of the turn portions from contacting.

11. The method of claim 10, further comprising using the channel members to hold the bend members against the respective turn portions of the conductor segments.

12. The method of claim 10, wherein each conductor segment has an substantially rectangular profile, and wherein each respective bend member covers only a portion of one side of the conductor segment.

13. The method of claim 10, wherein the channel member comprises a pair of channel members connected by the bend member, and wherein the attaching step comprises attaching the channel members to the conductor segments, thereby creating a force that holds the bend members in close proximity to the respective turn portions.

14. The method of claim 13, wherein the attaching step comprises turning the channel members of each pair in opposite directions to create the holding force.

15. The method of claim 13, wherein the attaching step tensions the channel members of each pair with respect to the respective conductor segments to create the holding force.

16. The method of claim 10, further comprising, after the installing step, coating at least a part of an exposed portion of the installed conductor segments with an insulating material.

17. A clip for electrically insulating and spacing adjacent conductors of an electric machine, comprising:
at least one channel member formed to at least partially enclose a cross-sectional area of an individual one of the conductors; and
at least one bend member extending from the channel member, the channel member being structured to hold the bend member in place against a conductor turn portion when the clip is attached to the conductor.

18. The clip according to claim 17, wherein the bend member is substantially flat.

19. The clip according to claim 17, wherein the bend member conforms to the shape of the conductor turn portion.

20. The clip according to claim 17, wherein the channel member comprises a pair of channel members connected by the bend member and being rotationally offset respecting one another, the rotational offset biasing the bend member into abutment with the conductor turn portion when the clip is attached to the conductor.

21. An assembly of an electric machine, comprising:
a plurality of conductor segments each having a turn portion; and
a plurality of clips each having a pair of channel members attached to respective ones of the conductor segments proximate the respective turn portions;
wherein the attached clips space adjacent ones of the conductor segments, and wherein the channel member pairs prevent adjacent ones of the conductor segments from contacting one another.

22. The assembly of claim 21, wherein, for a series of adjacent conductor segments, the clips are attached to every other conductor segment.
